(19) United States
(12) Patent Application Publication
(10) Pub. No.: US 2004/0015447 A1
(43) Pub. Date: Jan. 22, 2004

(54) Simulation calculation service providing method, system, and storage medium which stores program

(75) Inventor: Kenichiro Tsuda, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/620,340

(22) Filed: Jul. 17, 2003

(30) Foreign Application Priority Data
Jul. 22, 2002 (JP) 2002-212190

(51) Int. Cl. H04K 1/00

(52) U.S. Cl. 705/51

(57) ABSTRACT

In a simulation calculation service providing method, a simulation calculation condition is received from a user terminal apparatus as a user presented condition. The received user presented condition is registered. A bidding condition from a consultant in correspondence with the registered user presented condition is received from a consultant terminal apparatus. The user presented condition is compared with the bidding condition, and a bidding condition that coincides with the user presented condition is selected. The user terminal apparatus is inquired about whether the simulation calculation is to be executed on the basis of the selected bidding condition. The simulation calculation is executed in accordance with an answer to the inquiry. A simulation calculation service providing system, a server system, and a program are also disclosed.

### BACKGROUND OF THE INVENTION

The present invention relates to a simulation calculation service providing system which efficiently operates the simulation technology in each field by IT (Information Technology).

The conventional simulation technology has been used by causing some experts to independently prepare simulation calculation programs and computers, access computer centers via, e.g., telnet, or visit the computer centers to activate, on computers, simulation calculation programs resident at the centers.

The conventional technology however has the following problems.

To use the simulation technology by independently preparing simulation calculation programs and computers, users must prepare the hardware and software by themselves. Since the initial investment is enormous, the users are limited to well-funded simulation experts and research workers familiar to the simulation technology.

Additionally, since the users hold themselves responsible for the change/upgrading of application software, the maintenance, and the handling of accidents, they are required to have competences to some extent or more.

To use the simulation technology by accessing a computer center via telnet or the like, each user must prepare a server to be used to connect the Internet. This requires initial investment.

To use the simulation technology by activating, on a computer, a simulation calculation program that is resident at a computer center, the user must directly visit the computer center, and it is time-consuming.

As described above, there are high hurdles to be got over to use the simulation technology. For many other research workers who are potential users of the simulation technology, for example, temporary users and non-experts, it is substantially impossible to actually use the simulation technology.

### SUMMARY OF THE INVENTION

It is an object of the present invention to provide a simulation calculation service providing method and system which can increase opportunities to use simulation calculation and can easily be used on the basis of user's requests, and a storage medium which stores a program therefor.

In order to achieve the above object, according to the present invention, there is provided a simulation calculation service providing method of providing simulation calculation in a server system connected to a user terminal apparatus and a consultant terminal apparatus through a network, comprising the steps of receiving a condition of the simulation calculation from the user terminal apparatus as a user presented condition, registering the received user presented condition, receiving, from the consultant terminal apparatus, a bidding condition from a consultant in correspondence with the registered user presented condition, comparing the user presented condition with the bidding condition and selecting a bidding condition that coincides with the user presented condition, inquiring of the user terminal apparatus about whether the simulation calculation is to be executed on the basis of the selected bidding condition, and executing the simulation calculation in accordance with an answer to the inquiry.

### BRIEF DESCRIPTION OF THE DRAWINGS

FIG. 1 is a block diagram showing the arrangement of a simulation calculation service providing system according to an embodiment of the present invention;

FIG. 2 is a block diagram for explaining the arrangement of a server system according to the embodiment of the present invention;

FIG. 3 is a flow chart showing an operation of. executing simulation calculation by using a simulation calculation service providing system according to the first embodiment of the present invention;

FIG. 4 is a flow chart showing an operation of executing simulation trial calculation by using a simulation calculation service providing system according to the second embodiment of the present invention;

FIG. 5 is a flow chart showing an operation of executing simulation calculation related to proteins by using the simulation calculation service providing system according to the first embodiment of the present invention;

FIG. 6 is a flow chart showing the operation of executing simulation calculation related to proteins by using the simulation calculation service providing system according to the first embodiment of the present invention;

FIG. 7 is a flow chart showing the operation of executing simulation calculation related to proteins by using the simulation calculation service providing system according to the first embodiment of the present invention;

FIG. 8 is a flow chart showing the operation of executing simulation calculation related to proteins by using the simulation calculation service providing system according to the first embodiment of the present invention;

FIG. 9 is a flow chart showing an operation of executing simulation trial calculation related to proteins by using the simulation calculation service providing system according to the second embodiment of the present invention;

FIG. 10 is a flow chart showing the operation of executing simulation trial calculation related to proteins by using the simulation calculation service providing system according to the second embodiment of the present invention;

FIG. 11 is a flow chart showing the operation of executing simulation trial calculation related to proteins by using the simulation calculation service providing system according to the second embodiment of the present invention; and

FIG. 12 is a flow chart showing the operation of executing simulation trial calculation related to proteins by using the simulation calculation service providing system according to the second embodiment of the present invention.

### DESCRIPTION OF THE PREFERRED EMBODIMENTS

The embodiments of the present invention will be described next in detail with reference to the accompanying drawings.

The same reference numerals denote parts having the same functions throughout the drawings for explaining the embodiments, and a repetitive description will be omitted.

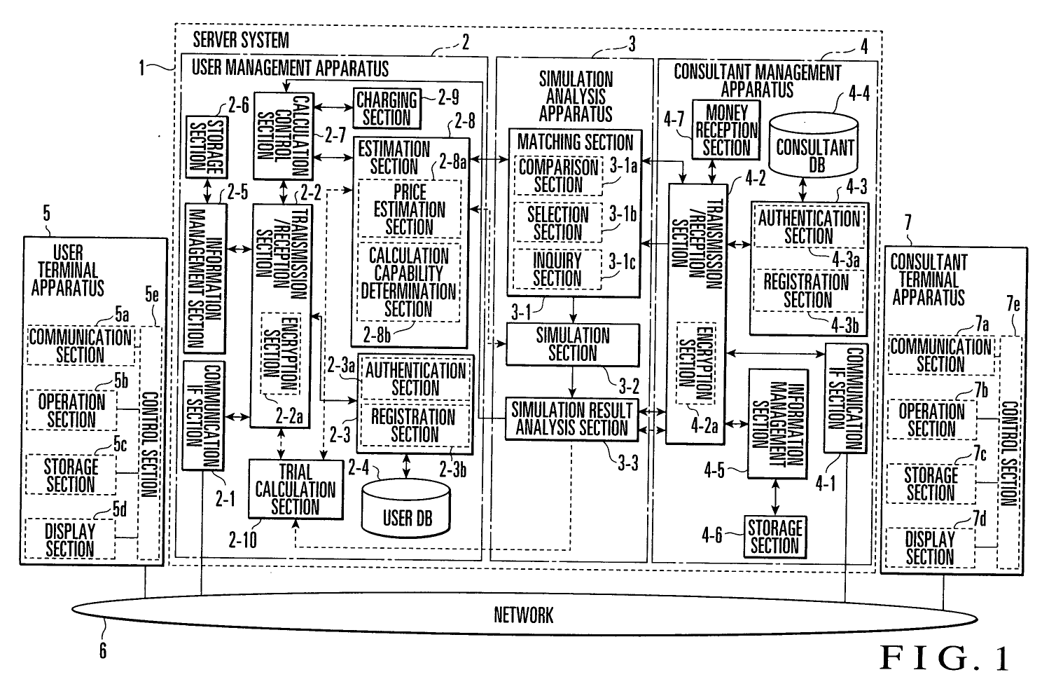

As shown in FIG. 1, a simulation calculation service providing system according to an embodiment of the present invention comprises a user terminal apparatus 5, consultant terminal apparatus 7, and server system 1. The server system 1 is constituted by a user management apparatus 2, simulation analysis apparatus 3, and consultant management apparatus 4.

The user terminal apparatus 5 comprises a control section 5e, and a communication section 5a, operation section 5b, storage section 5c, and display section 5d which are connected to the control section 5e.

The communication section 5a communicates information to the server system 1 through a network 6 such as the Internet. The operation section 5b inputs a received user's request or instruction to the control section 5e. The operation section 5b comprises at least one of, e.g., a browser, a graphical user interface, and any other input means and inputs a request or instruction by using the input means. The storage section 5c stores a program for the control section 5e, a browser, and a program which causes the user terminal apparatus 5 to execute functions installed in it. The storage section 5c inputs/outputs data to/from the control section 5e. The display section 5d is constituted by a display device such as an LCD. The display section 5d is controlled by the control section 5e to display a simulation condition input window or a simulation calculation result received from the server system 1. The control section 5e systematically controls the respective sections of the user terminal apparatus 5 on the basis of, e.g., a program.

The user terminal apparatus 5 is constituted by, e.g., a personal computer (PC), a cellular phone, or a PDA (Personal Digital Assistance). When the user terminal apparatus 5 is constituted by, e.g., a personal computer, a browser stored in the storage section of the personal computer is activated. Then, the address of the user management apparatus 2 (to be described later) is input to access it.

The consultant terminal apparatus 7 is a terminal apparatus similar to the user terminal apparatus 5. The consultant terminal apparatus 7 comprises a control section 7e, and a communication section 7a, operation section 7b, storage section 7c, and display section 7d which are connected to the control section 7e.

The communication section 7a communicates information to the server system 1 through the network 6 such as the Internet. The operation section 7b inputs a received consultant's request or instruction to the control section 7e. The operation section 7b comprises at least one of, e.g., a browser, a graphical user interface, and any other input means and inputs a request or instruction by using the input means. The storage section 7c stores a program for the control section 7e, a browser, and a program which causes the consultant terminal apparatus 7 to execute functions installed in it. The storage section 7c inputs/outputs data to/from the control section 7e. The display section 7d is constituted by a display device such as an LCD. The display section 7d is controlled by the control section 7e to display a bidding condition input window or a simulation calculation result received from the server system 1. The control section 7e systematically controls the respective sections of the consultant terminal apparatus 7 on the basis of, e.g., a program.

The consultant terminal apparatus 7 is constituted by, e.g., a personal computer (PC), a cellular phone, or a PDA (Personal Digital Assistance), like the user terminal apparatus 5. When the consultant terminal apparatus 7 is constituted by, e.g., a personal computer, a browser stored in the storage section of the personal computer is activated. Then, the address of the consultant management apparatus 4 (to be described later) is input to access it.

The server system 1 will be described next. The server system 1 is constituted by the user management apparatus 2, simulation analysis apparatus 3, and consultant management apparatus 4.

The user management apparatus 2 will be described first.

The user management apparatus 2 comprises a communication IF section 2-1, transmission/reception section 2-2, authentication/registration section 2-3, user DB (database) 2-4, information management section 2-5, storage section 2-6, calculation control section 2-7, estimation section 2-8, charging section 2-9, and encryption section 2-2a.

The communication IF section 2-1 is an interface to be used to transmit/receive data to/from the user terminal apparatus 5 through the network 6 such as the Internet. The communication IF section 2-1 is connected in parallel with a plurality of user terminal apparatuses 5 on the network 6.

The transmission/reception section 2-2 inputs/outputs data to/from the authentication/registration section 2-3, the calculation control section 2-7, and a trial calculation section 2-10 (to be described later) in accordance with a connection request from the user terminal apparatus 5. For example, the transmission/reception section 2-2 is connected to the authentication/registration section 2-3 in accordance with a connection request from the user terminal apparatus 5. In addition, the transmission/reception section 2-2 receives, as user presented conditions, simulation calculation conditions and request items related to the simulation calculation and inputs them to the calculation control section 2-7 or trial calculation section 2-10 (to be described later). The transmission/reception section 2-2 also inputs, to the information management section 2-5, an automatic price estimation result output from the estimation section 2-8. The transmission/reception section 2-2 also inputs, to the information management section 2-5, a simulation calculation result output from the calculation control section 2-7. The transmission/reception section 2-2 also inputs, to the information management section 2-5, a simulation trial calculation result output from the trial calculation section 2-10.

The authentication/registration section 2-3 comprises an authentication section 2-3a and registration section 2-3b.

The authentication section 2-3a causes a user who has already been registered as a member to input at least a system registration ID (identification) and a password to execute member authentication, and transmits a message representing use permission to the user who is granted permission to use by member authentication. Also, in accordance with a request from the user who is granted permission to use, the authentication section 2-3a transmits application software information and the input information of data necessary for the use of the application software to the user terminal apparatus 5.

The registration section 2-3b registers a user who wants to be registered as a member or a non-member user who wants to use the system by way of trial.

The user DB (database) 2-4 is a database which stores the information of users who have already been registered as members. When a user inputs his/her system registration ID and password in an authentication/registration window, the authentication section 2-3a executes authentication processing to determine whether the user who has input the system registration ID and password can use the system.

The information management section 2-5 registers, in the storage section 2-6 (to be described later), a price estimation result output from the estimation section 2-8 and a simulation calculation result output from the calculation control section 2-7. In response to an access request from the user terminal apparatus 5, the information management section 2-5 transmits an acknowledge signal for requested information.

The storage section 2-6 stores user presented conditions and simulation calculation result input from the information management section 2-5.

The calculation control section 2-7 executes control in simulation calculation. The calculation control section 2-7 inputs user presented conditions designated by the user to the estimation section 2-8 (to be described later). The calculation control section 2-7 also receives a simulation result output from the simulation analysis apparatus 3 (to be described later).

The estimation section 2-8 comprises a price estimation section 2-8a. The price estimation section 2-8 a estimates the price of simulation calculation on the basis of user presented conditions output from the calculation control section 2-7. As will be described later, the estimation section 2-8 also comprises a calculation capability determination section 2-8b which determines whether simulation calculation goes beyond the upper limit of the processing capability (computation capability) of the system when a user is going to use the simulation calculation service providing system by way of trial.

The charging section 2-9 charges a fee for the use of the system. For example, the charging section 2-9 charges a user who uses the system.

The trial calculation section 2-10 executes control for simulation trial calculation. The trial calculation section 2-10 inputs user presented conditions designated by the user to the estimation section 2-8. The trial calculation section 2-10 also inputs a simulation result output from the simulation analysis apparatus 3 to the transmission/reception section 2-2.

The encryption section 2-2a is arranged in the transmission/reception section 2-2 to encrypt information to be transmitted/received, i.e., inquiries, user presented conditions, bidding conditions, replies to inquiries, and the like.

The simulation analysis apparatus will be described next.

The simulation analysis apparatus 3 comprises a matching section 3-1, simulation section 3-2, and simulation result analysis section 3-3.

The matching section 3-1 is constituted by a comparison section 3-1a, selection section 3-1b, and inquiry section 3-1c. The comparison section 3-1a compares user presented conditions received from the estimation section 2-8 with bidding conditions designated by a consultant who has referred to the user presented conditions. The selection section 3-1b selects bidding conditions that are determined by the comparison section 3-1a to coincide with (match) the user presented conditions. The inquiry section 3-1c inquires of the user terminal apparatus 5 about whether simulation calculation should be executed on the basis of the bidding conditions selected by the selection section 3-1b. If the answer to this inquiry is “OK”, the inquiry section 3-1c inputs the matching simulation calculation conditions to the simulation section 3-2.

The simulation section 3-2 is constituted by a computer group having one or a plurality of computers and an application software group having one or a plurality of pieces of application software.

The simulation section executes simulation calculation on the basis of the conditions input from the matching section 3-1 by using the hardware of the computer group and the application software of the application software group. The simulation section inputs the simulation calculation result to the simulation result analysis section 3-3.

The computer group may be prepared by a public organization such as a state or a community comprised of one or a plurality of companies that are planning business using simulation. The operation cost may be covered with fees for the computers, which are paid by consultants or users. The application software group may be provided by simulation experts or IT operators. Alternatively, it may be provided to penetrate developed simulation technologies or software and prove their effectiveness. In this case, a corresponding value may be paid by the operator who is operating the system.

The simulation result analysis section 3-3 temporarily stores the simulation calculation result output from the simulation section 3-2 and transmits a copy of the simulation calculation result to the consultant management apparatus 4 (to be described later).

The simulation result analysis section 3-3 also receives intellectual added value information such as an analysis result added by the consultant who has referred to the simulation calculation result and transmits the intellectual added value information to the user terminal apparatus 5 together with the simulation calculation result.

The consultant management apparatus 4 will be described next.

The consultant management apparatus 4 comprises a communication IF section 4-1, transmission/reception section 4-2, authentication/registration section 4-3, consultant DB 4-4, information management section 4-5, storage section 4-6, and money reception section 4-7.

The communication IF section 4-1 is an interface to be used to transmit/receive data to/from the consultant terminal apparatus 7 through the network 6 such as the Internet. The communication IF section 4-1 is connected in parallel with a plurality of consultant terminal apparatuses 7 on the network 6.

The transmission/reception section 4-2 inputs/outputs data to/from the authentication/registration section 4-3 (to be described later), matching section 3-1, and simulation result analysis section 3-3 in accordance with a request from the consultant terminal apparatus 7. For example, the transmission/reception section 4-2 is connected to the authentication/registration section 4-3 in accordance with a connection request from the consultant terminal apparatus 7. In addition, the transmission/reception section 4-2 receives user presented conditions from the matching section 3-1 and inputs them to the information management section 4-5 (to be described later). The transmission/reception section 4-2 also receives a simulation calculation result for the simulation result analysis section 3-3 and transmits it to the consultant terminal apparatus 7. The transmission/reception section 4-2 also receives intellectual added value information from the consultant terminal apparatus 7 and transmits it to the simulation result analysis section 3-3.

The transmission/reception section 4-2 also registers new application software or changes/upgrades application software in the simulation section 3-2.

The authentication/registration section 4-3 comprises an authentication section 4-3a and registration section 4-3b.

The authentication section 4-3a causes a consultant who has already been registered as a member to input at least a system registration ID (identification) and a password to execute member authentication, and transmits a message representing use permission to the consultant who is granted permission to use by member authentication.

The registration section 4-3b registers a non-member consultant who will use the system.

The consultant DB (database) 4-4 is a database which stores the information of consultants who have already been registered as members. When a consultant inputs his/her system registration ID and password in an authentication/registration window, the authentication/registration section 4-3 executes authentication processing to determine whether the consultant who has input the system registration ID and password can use the system.

The information management section 4-5 stores, in the storage section 4-6 (to be described later), user presented conditions output for the matching section 3-1 and a simulation calculation result output from the simulation result analysis section 3-3. In response to an access request from the consultant terminal apparatus 7, the information management section 4-5 transmits an acknowledge signal for requested information.

The storage section 4-6 stores user presented conditions and simulation calculation result input from the information management section 4-5.

The money reception section 4-7 receives compensation for a consultant. For example, an amount obtained by deducting a commission from an amount paid by a user is paid as compensation by the operation entity that operates the system.

The arrangement of the server system 1 according to this embodiment will be described next.

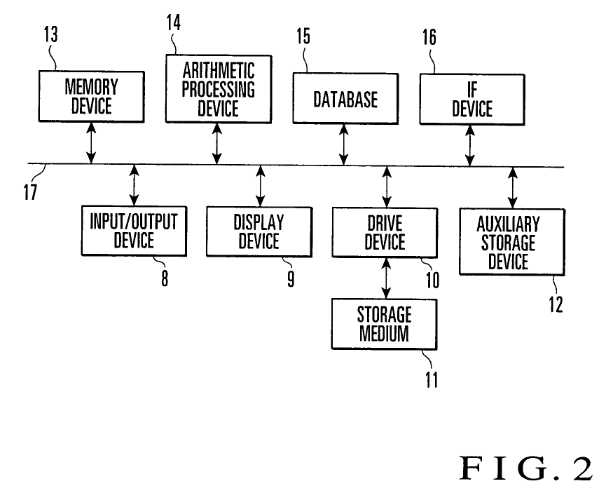

As shown in FIG. 2, the server system 1 is constituted by an input/output device 8, display device 9, drive device 10, storage medium 11, auxiliary storage device 12, memory device 13, arithmetic processing device 14, database (DB) 15, and IF device 16. The interface (IF) device 16 is connected to the user terminal apparatus 5 and consultant terminal apparatus 7 through the network 6.

The input/output device 8 is formed from a keyboard and mouse operated by the manager of the server system 1, and used to input various operation signals to the server system 1.

The display device 9 displays various kinds of windows and data necessary for operating the server system 1.

The interface device 16 is an interface used to connect the server system 1 to the network 6 and is formed from, e.g., a modem.

The database 15 is designed to include, e.g., the user DB 2-4 and consultant DB 4-4.

A simulation calculation service providing program related to the simulation calculation service providing system is provided by a software package, i.e., the information storage medium 11 such as a CD-ROM, ROM, RAM, flexible disk, or memory card. When the storage medium 11 which stores the simulation calculation service providing program is set in the drive device 10, the program is installed from the storage medium 11 to the auxiliary storage device 12 through the drive device 10.

The auxiliary storage device 12 stores the installed simulation calculation service providing program and also necessary files and data.

At the time of activating the server system, the memory device 13 reads out the simulation calculation service providing program from the auxiliary storage device 12 and stores the program.

The simulation calculation service providing program may be provided through telecommunication, and for example, by a server.

The arithmetic processing device 14 executes processing of the simulation calculation service providing system in accordance with the simulation calculation service providing program read out and stored in the memory device 13.

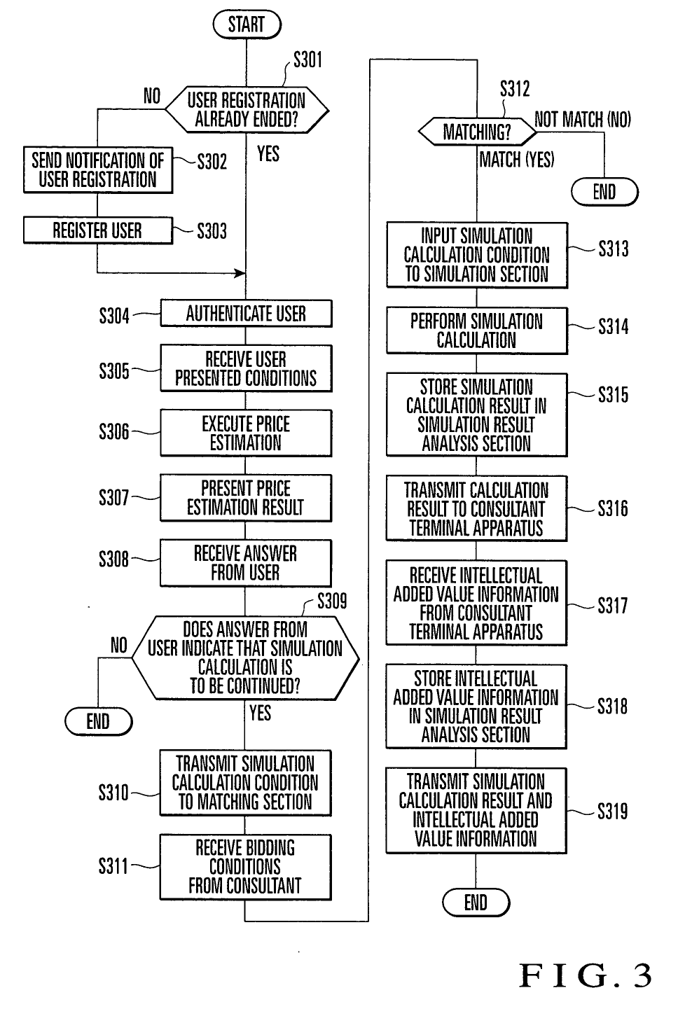

The processing of the simulation calculation service providing system according to this embodiment will be described next with reference to FIG. 3.

The user operates the user terminal apparatus 5 and activates a browser stored in the storage section 5c to access the user management apparatus 2 through the network 6.

The authentication/registration section 2-3 of the user management apparatus 2 confirms whether the user who is accessing it has already been registered (S301).

If user registration is not executed yet (NO in S301), a notification representing that the user should be registered is sent (S302), and user registration is performed (S303).

When the user has already been registered (YES in S301), a user authentication window is displayed. The user inputs the user ID and password, and after authentication processing is done, logs in (S304).

When the user is granted permission to use as a result of authentication processing, a window in which simulation conditions and request items related to simulation calculation are to be input is displayed on the display section 5d of the user terminal apparatus 5 that is accessing the user management apparatus 2. The user inputs desired simulation calculation conditions and request items.

For example, an edit box in which simulation calculation conditions and request items related to simulation calculation are to be input and a command button “transmit” are displayed. The user inputs simulation calculation conditions and request items to the blank field of the edit box. When input is ended, the user clicks on the “transmit” button by using, e.g., the mouse. Accordingly, the simulation calculation conditions and request items are transmitted to the user management apparatus 2.

The transmitted simulation conditions and request items are received by the transmission/reception section 2-2 as user presented conditions (S305). The user presented conditions received by the transmission/reception section 2-2 are input to the calculation control section 2-7. The user presented conditions are input from the calculation control section 2-7 to the estimation section 2-8. The estimation section 2-8 automatically estimates the price of simulation on the basis of the received user presented conditions (S306). The estimation result is input to the transmission/reception section 2-2. The transmission/reception section inputs the received price estimation result to the information management section 2-5. The information management section 2-5 registers the received price estimation result in the storage section 2-6 and presents the price (S307). The user terminal apparatus 5 can refer to the price estimation result by accessing the information management section 2-5.

The user refers to the price estimation result and examines whether the simulation calculation is to be continued or the system is to be ended without executing the simulation calculation. When the simulation calculation should be continued, the user examines whether the simulation calculation should be executed on the basis of the current conditions or re-examines the simulation calculation conditions, and transmits the examination result. This operation is done by, e.g., displaying the simulation condition input window again and causing the user to input simulation conditions again.

The examination result transmitted from the user terminal apparatus 5 is received by the transmission/reception section 2-2 of the user management apparatus 2 (S308).

When the examination result indicates that the simulation calculation should be continued (YES in S309), the simulation calculation conditions are input from the transmission/reception section 2-2 to the estimation section 2-8 through the calculation control section 2-7.

When the received examination result indicates that no simulation calculation should be executed (NO in S309), the system is ended (S309).

The estimation section 2-8 estimates the price again on the basis of the newly input user presented conditions. The estimation result is transmitted to the matching section 3-1 of the simulation analysis apparatus 3 together with the user presented conditions (S310).

The user presented conditions and price estimation result transmitted to the matching section 3-1 are transmitted to the transmission/reception section 4-2 of the consultant management apparatus 4. Upon receiving the user presented conditions and price estimation result, the transmission/reception section 4-2 inputs the user presented conditions and price estimation result to the information management section 4-5. The information management section 4-5 registers the received user presented conditions and automatic price estimation result in the storage section 4-6.

On the other hand, a single consultant or each of a plurality of consultants operates the consultant terminal apparatus 7 connected to the consultant management apparatus 4 through the network 6 and activates a browser stored in the storage section to access the consultant management apparatus 4. The authentication/registration section 4-3 confirms whether the consultant who is accessing it has already been registered as a consultant.

If consultant registration is not executed yet, the registration section sends a notification representing that the consultant should be registered and performs consultant registration.

A notification representing the presence/absence of matters presented by users may be automatically transmitted to registered consultants by email or the like. Alternatively, the matters may be open to the public on homepages or the like.

When the consultant has already been registered, a user authentication window is displayed. The consultant inputs the consultant ID and password and logs in.

When the consultant is granted permission to use as a result of authentication processing, the transmission/reception section 4-2 accesses the information management section 4-5. Consequently, a list of user presented conditions and automatic price estimation results is displayed on the display screen of the consultant terminal apparatus 7. The consultant selects user presented conditions and an automatic price estimation result, for which he/she wants to offer consultations, from the list of user presented conditions and automatic price estimation results, and inputs and transmits bidding conditions on the basis of the selected user presented conditions and automatic price estimation result.

The bidding conditions transmitted from the consultant terminal apparatus 7 are received by the transmission/reception section 4-2 of the consultant management apparatus 4 (S311) and transmitted to the matching section 3-1 of the simulation analysis apparatus 3.

The matching section 3-1 compares the user presented conditions with bidding conditions, selects bidding conditions that coincide with (match) the user presented conditions, and inquires of the user terminal apparatus 5 about whether simulation calculation is to be executed on the basis of the selected bidding conditions.

If the answer to this inquiry is “OK” (YES in S312), simulation calculation conditions of the user presented conditions that coincide with the bidding conditions are input to the simulation section (S313).

The simulation section 3-2 automatically executes simulation calculation on the basis of the received simulation calculation conditions (S314).

The simulation calculation result is input to the simulation result analysis section 3-3 and temporarily stored (S315). A copy of the simulation calculation result is sent to the consultant who has got the contract (made a successful bid) for the simulation calculation through the consultant terminal apparatus 7 (S316).

The consultant adds intellectual added value information such as an analysis result or the explanation of the result while referring to the received simulation calculation result and returns the intellectual added value information to the simulation result analysis section 3-3.

Upon receiving the intellectual added value information (S317), the simulation result analysis section 3-3 temporarily stores it (S318) and transmits the received intellectual added value information and the simulation calculation result to the user terminal apparatus 5 (S319).

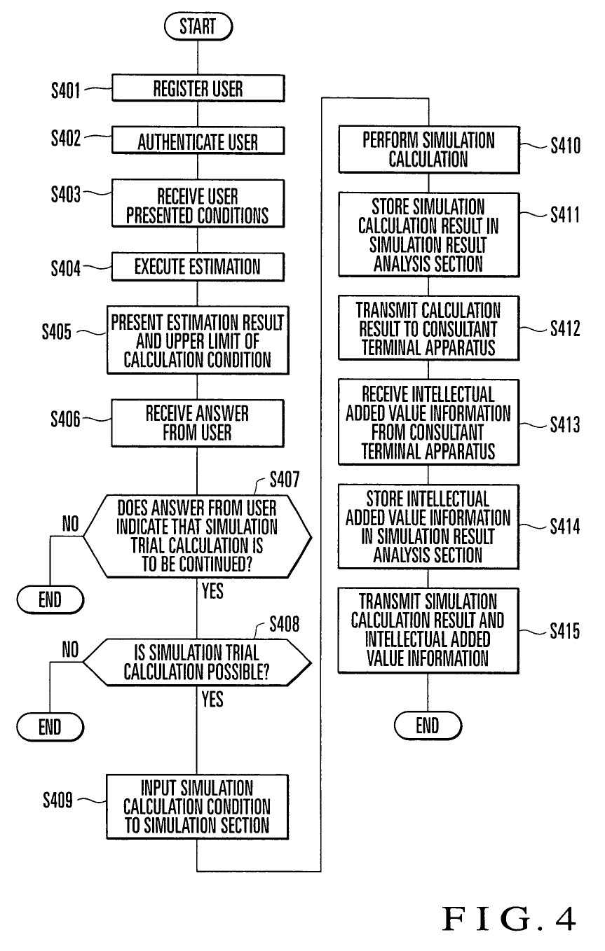

A case wherein the user is to use the simulation calculation service providing system by way of trial will be described next with reference to FIG. 4.

The user operates the user terminal apparatus 5 and activates a browser stored in the storage section 5c to access the user management apparatus 2 through the network 6.

The authentication/registration section 2-3 of the user management apparatus 2 executes user registration for the user who is accessing it (S401).

User authentication may be performed after user registration (S402).

When the user is granted permission to use as a result of authentication processing, a window in which simulation conditions and request items related to simulation calculation are to be input is displayed on the display section of the user terminal apparatus 5 that is accessing the user management apparatus 2. The user inputs desired simulation calculation conditions and request items.

For example, an edit box in which simulation calculation conditions and request items related to simulation calculation are to be input and a command button “transmit” are displayed. The user inputs simulation calculation conditions and request items to the blank field of the edit box. When input is ended, the user clicks on the “transmit” button by using, e.g., the mouse. Accordingly, the simulation calculation conditions and request items are transmitted to the user management apparatus.

The transmitted simulation conditions and request items are received by the transmission/reception section 2-2 as user presented conditions (S403). The user presented conditions received by the transmission/reception section 2-2 are input to the trial calculation section 2-10. The user presented conditions are input from the trial calculation section 2-10 to the estimation section 2-8. The estimation section 2-8 estimates the price of simulation calculation on the basis of the received user presented conditions and determines whether the simulation calculation goes beyond the upper limit of the processing capability (computation capability) of the system (S404). The result is input to the transmission/reception section 2-2. The transmission/reception section 2-2 inputs the received estimation result to the information management section 2-5. The information management section 2-5 stores the received estimation result in the storage section 2-6 (S405). The user can refer to the estimation result by operating the user terminal apparatus 5 and accessing the information management section 2-5.

The user refers to the estimation result and examines whether the simulation trial calculation is to be continued or the system is to be ended without executing the simulation trial calculation. When the simulation trial calculation should be continued, the user examines whether the simulation trial calculation should be executed on the basis of the current conditions or re-examines the simulation trial calculation conditions, and transmits the examination result. This operation is done by, e.g., displaying the simulation condition input window again and causing the user to input simulation conditions again.

The examination result transmitted from the user terminal apparatus 5 is received by the transmission/reception section 2-2 of the user management apparatus 2 (S406).

When the examination result indicates that the simulation trial calculation should be continued (YES in S407), the simulation trial calculation conditions are input from the transmission/reception section 2-2 to the estimation section 2-8 through the trial calculation section 2-10.

When the received examination result indicates that no simulation trial calculation should be executed (NO in S407), the system is ended.

On the basis of the newly input user presented conditions, the estimation section 2-8 automatically estimates the price and determines whether the simulation trial calculation goes beyond the upper limit of the processing capability of the system (S408). If the simulation trial calculation goes beyond the upper limit of the processing capability of the system, and trial calculation cannot be executed, the system is ended (NO in S408).

When the simulation trial calculation falls within the limit of the processing capability of the system, and trial calculation can be executed (YES in S408), the simulation calculation conditions are input to the simulation section 3-2 (S409).

The simulation section 3-2 automatically executes the simulation calculation on the basis of the received simulation calculation conditions (S410).

The simulation calculation result is input to the simulation result analysis section 3-3 and temporarily stored (S411). A copy of the simulation calculation result is sent to the consultant who has got the contract for the simulation calculation through the consultant terminal apparatus 7 (S412).

The consultant adds intellectual added value information such as an analysis result or the explanation of the result while referring to the received simulation calculation result and returns the intellectual added value information to the simulation result analysis section 3-3.

Upon receiving the intellectual added value information (S413), the simulation result analysis section 3-3 temporarily stores it (S414) and transmits the received intellectual added value information and the simulation calculation result to the user terminal apparatus 5 (S415).

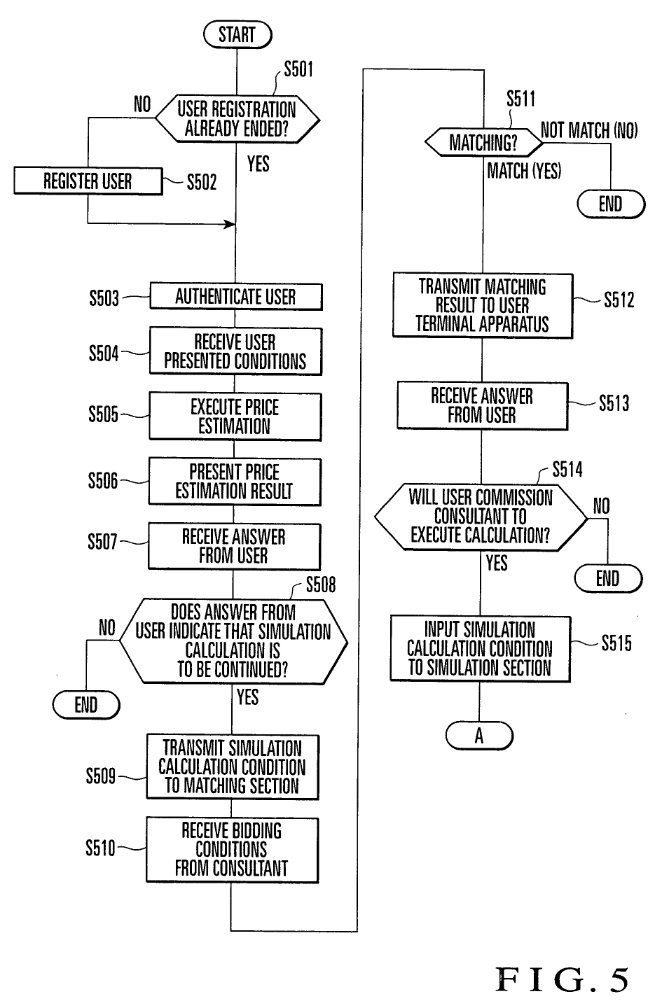

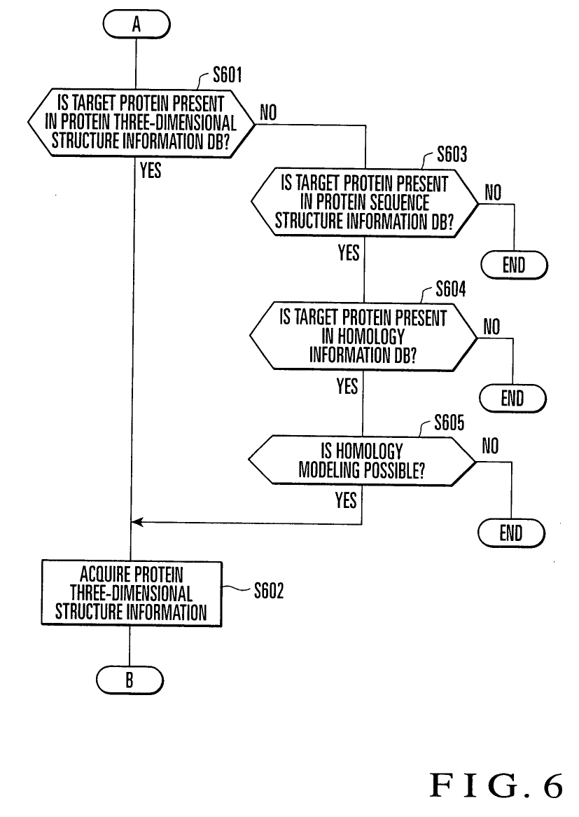

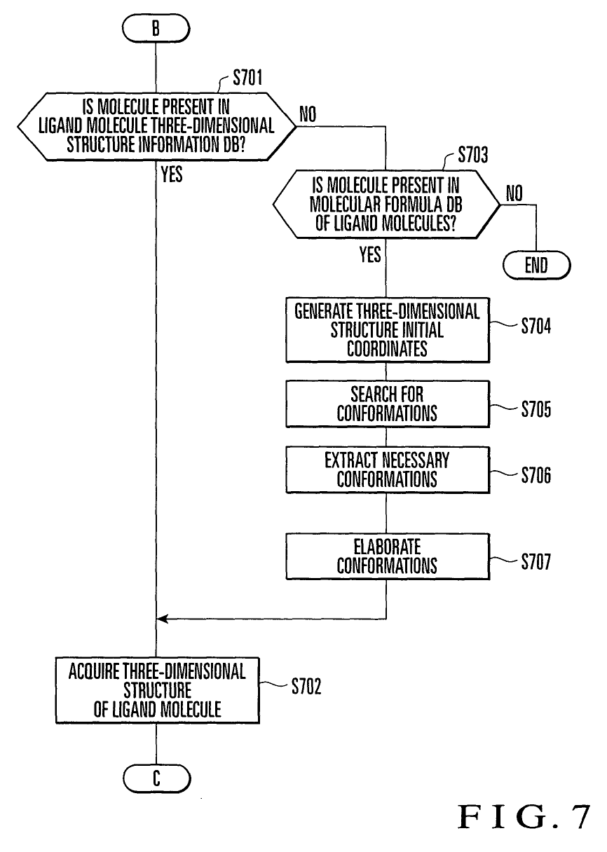

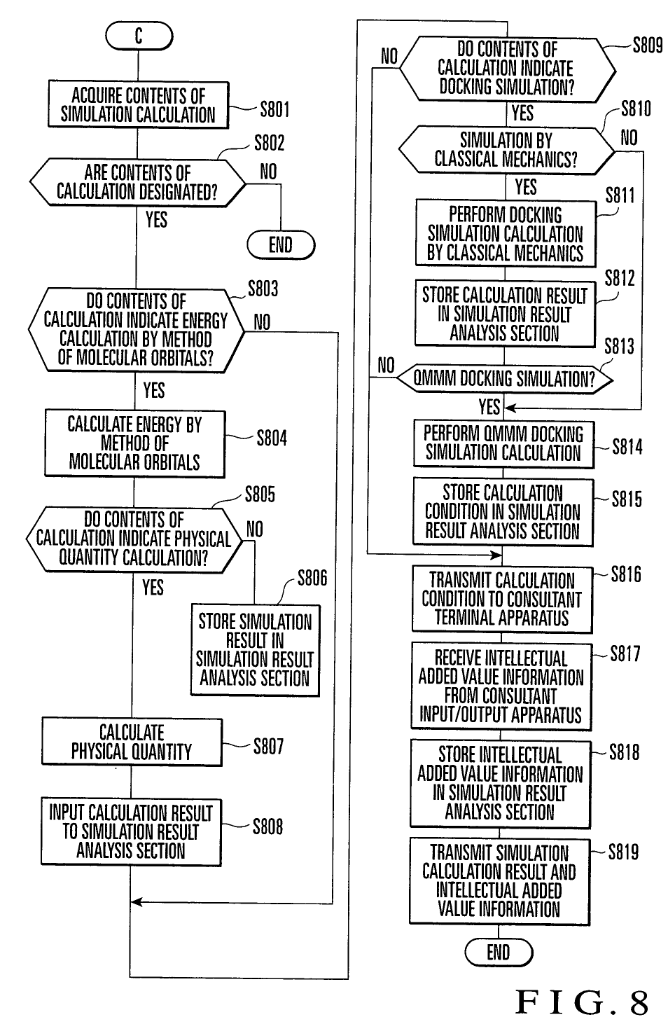

An example will be described next with reference to FIGS. 5 to 8, in which when target protein function control which is effective in the drug design field is to be executed by using the above-described simulation calculation service providing system, pieces of information about portions of the target protein, to which molecules as drug candidates bind, and the difference in affinity to the respective portions are to be collected.

The user operates the user terminal apparatus 5, activates a browser stored in the storage section 5c, and, for example, designates the address of the user management apparatus 2 on the browser to access the user management apparatus 2 through the network 6 such as the Internet.

The authentication/registration section 2-3 of the user management apparatus 2 confirms whether the user who is accessing it has already been registered (S501).

If user registration is not executed yet (NO in S501), a notification representing that the user should be registered is sent, and user registration is performed (S502). The user registration may be charged.

When the user has already been registered (YES in S501), a user authentication window is displayed.

The user inputs the user ID and password and logs in (S503).

When the user is granted permission to use as a result of authentication processing, a window in which simulation calculation conditions and request items related to simulation calculation are to be input is displayed on the display section 5d of the user terminal apparatus 5 that is accessing the user management apparatus 2. The user inputs desired simulation calculation conditions and request items related to the simulation calculation.

TABLE 1
User Presented Conditions

| | | Contents of Simulation Calculation | | | | |
|---|---|---|---|---|---|---|
| | | Three- | | | | |
| Delivery | | Dimensional | | | | Priority |
| Time | Price | Structure | Energy | Property | Docking | Item |
| 30 | 200 | YES | YES | YES | YES | Delivery |
| | | YES | YES | YES | | time |
| Number | Number | Composition | Three- | Sequence | Homology | Binding |
| of amino | of | | dimensional | information | | site |
| acid | atoms | | structure | | | |
| residues | | | information | | | |
| 100 | 1500 | Amino acid | UNKNOWN | UNKNOWN | UNKNOWN | UNKNOWN |
| — | 60 | Organic | UNKNOWN | — | — | 10 |

For example, simulation calculation conditions and request items related to simulation calculation in molecular binding simulation (docking simulation) include “contents of simulation calculation”, “information about molecules to be calculated”, “delivery time”, “price”, “priority item”, and “rank”, as shown in Table 1. The request items can be added or changed by the manager or user of the system, as needed.

The contents of simulation calculation include “three-dimensional structure predictive calculation (three-dimensional structure)”, “three-dimensional structure predictive calculation and energy calculation (energy)”, “physical quantity (property) calculation” such as electrostatic potential calculation, and “molecular binding simulation (docking simulation)”. When molecular binding simulation is to be executed, the number of binding site candidate portions of a protein molecule, where docking simulation should be executed, is designated.

Information about molecules to be calculated contains “number of amino acid residues”, “number of atoms”, “composition”, “three-dimensional structure information”, “sequence information”, “homology”, and “binding site”.

For example, “composition” designates whether a molecule is comprised of an amino acid. “Three-dimensional structure information” designates whether the three-dimensional structure is known. “Sequence information” designates whether the sequence information is known. “Homology” designates whether the presence/absence of homology is known. “Binding site” designates whether the binding site is known or the number of binding site candidate portions where calculation should be executed. These pieces of information are designated for each of the target molecule and substrate molecule.

“Priority item” is an item which has high priority in comparing user presented conditions with bidding conditions designated by a consultant who has referred to the user presented conditions and selecting bidding conditions that coincide with (match) the user presented conditions. “Priority item” includes items designated in the user presented conditions, and here, “delivery time”, “price”, and “contents of simulation calculation”.

“Rank” is an index to be used to identify the technical capability of each consultant. Each consultant is given a rank at the time of registration. For example, A, B, and C are given as ranks in descending order of technical capability of consultants. The rank changes in accordance with the actual performance in this system.

In this embodiment, “delivery time” is designated on a day-by-day basis. “Price” is designated in steps of 1 dollar. “Three-dimensional structure”, “property”, “, and “docking” are designated by YES/NO. “Three-dimensional structure information”, “sequence information”, “homology”, and “binding site” are designated by KNOWN/UNKNOWN.

For “binding site”, the number of binding sites for which docking simulation is to be executed. When “binding site” is UNKNOWN, the number of sites to be calculated is designated. When “binding site” is KNOWN, the number of known sites is designated.

In the user presented conditions shown in Table 1, “delivery time” is 30 days, and “price” is 200 dollar. In “contents of simulation calculation, both the target molecule and substrate molecule are designated as “YES” in “three-dimensional structure predictive calculation”, “energy calculation (energy)”, physical quantity (property)”, and “molecular binding simulation (docking simulation)”. “Priority item” is “delivery time”.

In “information about molecules to be calculated”, for the target molecule, “number of amino acid residues” is 100, “number of atoms” is 1,500, “composition” is amino acid, “three-dimensional structure information” is UNKNOWN, “sequence information” is UNKNOWN, “homology” is UNKNOWN, and “binding site” is UNKNOWN. For the substrate molecule, “number of atoms” is 60, “composition” is organic, “three-dimensional structure information” is UNKNOWN, and “number of sites to be calculated” is 10.

The transmitted simulation calculation conditions and request items are received by the transmission/reception section 2-2 as user presented conditions (S504). The user presented conditions received by the transmission/reception section 2-2 are input to the calculation control section 2-7. The user presented conditions are input from the calculation control section 2-7 to the estimation section 2-8.

The estimation section 2-8 automatically estimates the price of simulation calculation on the basis of the received user presented conditions (S505). The estimation section 2-8 roughly estimates the calculation time on the basis of the received user presented conditions by using a molecular simulation method such as homology search or a method of molecular orbitals/molecular dynamics. The estimation section 2-8 also automatically roughly estimates the price corresponding to the calculation contents. For example, the price is automatically calculated from an estimated CPU processing time, and for example, an estimated calculation time and a point defined in advance in correspondence with the level of calculation contents.

A plurality of price estimation results are presented on the basis of the priority item designated in the user presented conditions. In the plurality of estimated conditions presented to the user, items except the priority item designated in the user presented conditions do not always match the user's desired conditions.

TABLE 2
Price Estimation Results

Contents of Simulation Calculation

| Delivery | | Three-Dimensional | | | | Binding |
|---|---|---|---|---|---|---|
| Time | Price | Structure | Energy | Property | Docking | Site |
| 14 | 150 | YES | YES | YES | NO | 0 |
| | | YES | YES | YES | | |
| 21 | 300 | YES | YES | YES | YES | 10 |
| | | YES | YES | YES | | |
| 30 | 400 | YES | YES | YES | YES | 10 |
| | | YES | YES | YES | | |
| Immediate | 1000 | YES | NO | YES | NO | 0 |
| | | YES | NO | YES | | |

As shown in Table 2, the price estimation result includes, e.g., “delivery time”, “price”, “contents of simulation calculation”, and “binding site”.

For the delivery time, since the priority item designated in the user presented conditions in Table 1 is “delivery time” of 30 days, price estimations that satisfy the delivery time of 30 days are displayed.

For “price”, “contents of simulation calculation”, and “binding site”, since they are not designated as priority items, even conditions that do not satisfy the user presented conditions are displayed.

A price estimation is calculated by defining points in advance for the respective items of the user presented conditions shown in Table 1 and totalizing the points.

The price estimation result is input to the transmission/reception section 2-2. The transmission/reception section 2-2 inputs the received price estimation result to the information management section 2-5. The information management section 2-5 stores the received price estimation result in the storage section 2-6 (S506). The user can refer to the price estimation result by operating the user terminal apparatus 5 and accessing the information management section 2-5.

The user refers to the price estimation result and examines whether the simulation calculation is to be continued or the system is to be ended without executing the simulation calculation. When the simulation calculation should be continued, the user examines whether the simulation calculation should be executed on the basis of the current conditions or re-examines the simulation calculation conditions, and transmits the examination result.

The examination result transmitted from the user terminal apparatus 5 is received by the transmission/reception section 2-2 of the user management apparatus 2 (S507).

When the examination result indicates that the simulation calculation should be continued (YES in S508), the user presented conditions are input from the transmission/reception section 2-2 to the estimation section 2-8 through the calculation control section 2-7. The estimation section 2-8 estimates the price again on the basis of the newly input user presented conditions. The result is transmitted to the matching section 3-1 of the simulation analysis apparatus 3 together with the user presented conditions (S509).

When the received examination result indicates that no simulation calculation should be executed, the system is ended (NO in S508).

TABLE 3
User Presented Conditions Transmitted
to Matching Section

| | | Contents of Simulation Calculation | | | | |
|---|---|---|---|---|---|---|
| | | Three- | | | | |
| Delivery | | Dimensional | | | | Priority |
| Time | Price | Structure | Energy | Property | Docking | Item |
| 30 | 400 | YES | YES | YES | YES | Delivery |
| | | YES | YES | YES | | time |
| Number | Number | Composition | Three- | Sequence | Homology | Binding |
| of amino | of | | dimensional | information | | site |
| acid | atoms | | structure | | | |
| residues | | | information | | | |
| 100 | 1500 | Amino acid | UNKNOWN | UNKNOWN | UNKNOWN | 10 |
| — | 60 | Organic | UNKNOWN | — | — | |

Other condition: Rank is at least A

For example, when the user refers to the estimation result and changes the user presented conditions to those shown in Table 3, the changed conditions are transmitted to the matching section. In this example, “price” is changed from 200 dollar to 400 dollar, “binding site” is changed from UNKNOWN to KNOWN, “number of known sites” is set to 10, and “consultant rank” is designated as at least A.

The user presented conditions and price estimation result transmitted to the matching section 3-1 are transmitted to the transmission/reception section 4-2 of the consultant management apparatus 4. Upon receiving the user presented conditions and price estimation result, the transmission/reception section 4-2 inputs the user presented conditions and automatic price estimation result to the information management section 4-5. The information management section 4-5 registers the received user presented conditions and price estimation result in the storage section 4-6.

The consultant accesses the consultant management apparatus 4 and refers to a list of user presented conditions and automatic price estimation results.

The consultant selects user presented conditions and an automatic price estimation result, for which he/she wants to offer consultations, from the list of user presented conditions and automatic price estimation results, and inputs and transmits bidding conditions on the basis of the selected user presented conditions and automatic price estimation result.

The bidding conditions transmitted from the consultant terminal apparatus 7 are received by the transmission/reception section 4-2 of the consultant management apparatus 4 and transmitted to the matching section 3-1 of the simulation analysis apparatus 3.

TABLE 4
Bidding Conditions from Consultants

| | | | | Simulation |
|---|---|---|---|---|
| Consultant | Delivery Time | Price | Rank | Method |
| A | 14 | 500 | B | 1 |
| B | 30 | 300 | A | 1 |
| C | 14 | 400 | A | 1 |
| D | 21 | 300 | B | 2 |
| E | 30 | 200 | C | 1 |

As shown in Table 4, bidding conditions from consultants include, e.g., “consultant”, “delivery time”, “price”, “rank”, and “simulation method”.

Consultants who have referred to the user presented conditions and transmitted bidding conditions are displayed in the “consultant” field.

Delivery times and prices designated by the consultants are displayed in the “delivery time”, “price”, and “simulation method” fields.

The ranks may be either input by the consultants themselves or automatically displayed by the system.

In the bidding conditions, since the priority item designated in the user presented conditions is “delivery time”, bidding conditions that satisfy the delivery time are transmitted to the matching section 3-1.

For example, when the priority item designated in the user presented conditions is “price”, bidding conditions that satisfy the designated price are transmitted to the matching section 3-1.

Upon receiving the bidding conditions (S510), the matching section 3-1 compares the user presented conditions with the received bidding conditions, selects bidding conditions that coincide with (match) the user presented conditions (YES in S511), and inquires of the user terminal apparatus 5 about whether simulation calculation is to be executed on the basis of the selected bidding conditions (S512).

In selecting bidding conditions, comparison is done in the order of priority items (e.g., “delivery time”, “price”, “calculation method”, and “rank”) designated in the user presented conditions. A consultant who has presented optimum conditions makes a successful bid. If no priority item is designated, comparison is performed in the order of “delivery time”, “price”, “calculation method”, and “rank”. Even if the conditions do not completely coincide with each other, optimum conditions for the user presented conditions are selected. If no bidding conditions coincide with the user presented conditions, the system is ended (NO in S511).

Referring to the user presented conditions shown in Table 3 and the bidding conditions shown in Table 4, the priority item designated in the user presented conditions is “delivery time”. Hence comparison is done in the order of “delivery time”, “price”, “calculation method”, and “rank”.

Since the delivery time designated in the user presented conditions is 30 days, all consultants satisfy the condition. All consultants except A satisfy the condition of price. No condition is designated as “calculation method”. When the ranks are compared, consultants B and C satisfy the condition.

Upon receiving the answer to the inquiry from the user terminal apparatus 5 (S513), the matching section 3-1 determines whether the answer indicates that the user will commission the selected consultant to execute simulation calculation (S514). When the selected consultant is to be commissioned to execute simulation calculation, the simulation conditions are input to the simulation section 3-2 (YES in S515). When the answer indicates that the user will not commission the selected consultant to execute simulation calculation, the system is ended (NO in S515).

Upon receiving the simulation calculation conditions, the simulation section 3-2 first searches for the three-dimensional structure of the target protein (S601).

The simulation section 3-2 has, e.g., a protein three-dimensional structure information DB (not shown), a protein sequence structure DB (not shown), and a homology information DB (not shown). The protein three-dimensional structure information DB stores information of the three-dimensional structures of proteins. The protein sequence structure DB stores information of the sequence structures of proteins. The homology information DB stores information of homology of proteins.

The three-dimensional structure of the target protein is searched for first by searching the protein three-dimensional structure information DB (S601). If it is determined as a result of search that the target protein is present in the protein three-dimensional structure information DB (YES in S601), protein three-dimensional structure information is acquired (S602).

When the target protein is not present in the protein three-dimensional structure information DB (NO in S601), the sequence information of the target protein is searched for (S603). The sequence information of the target protein is searched for by searching the protein sequence structure DB. If it is determined as a result of search that the sequence information of the target protein is present in the protein sequence structure DB (YES in S603), homology information is searched for. When the sequence information of the target protein is not present in the protein sequence structure DB, the system is ended (NO in S603).

Homology information is searched for by searching the homology information DB (S604). If it is determined as a result of search that the sequence information of the target protein is present in the homology information DB (YES in S604), it is determined whether the three-dimensional structure can be estimated by using a method such as homology modeling (S605). If the sequence information of the target protein is not present in the homology information DB, the system is ended (NO in S604).

When the three-dimensional structure can be estimated, the estimated protein three-dimensional structure information is acquired (S602). If the three-dimensional structure cannot be estimated, the system is ended. If the calculation is impossible because of the performance of the computer prepared in the simulation section 3-2, the user may be notified of it.

Search of the three-dimensional structure of a molecule as a drug candidate will be described next.

For example, when no three-dimensional structure information is present, it is estimated from sequence information or by using a method of molecular mechanics, molecular dynamics, or molecular orbitals.

For example, the simulation section 3-2 has a ligand molecule three-dimensional structure information DB (not shown) and a molecular formula DB (not shown) of ligand molecules. The ligand molecule three-dimensional structure information DB stores information of the three-dimensional structures of ligand molecules. The molecular formula DB of ligand molecules stores information of the molecular formulas of ligand molecules.

The three-dimensional structure of a molecule as a drug candidate is searched for by searching the ligand molecule three-dimensional structure information DB (S701). If it is determined as a result of search that the molecule as the drug candidate is present in the ligand molecule three-dimensional structure information DB (YES in S701), the ligand molecule three-dimensional structure information is acquired (S702).

When the molecule as the drug candidate is not present in the ligand molecule three-dimensional structure information DB (NO in S701), the molecular formula of the molecule as the drug candidate is searched for (S703). The molecular formula of the molecule as the drug candidate is searched for by searching the molecular formula DB of ligand molecules.

If it is determined as a result of search that the molecular formula of the molecule as the drug candidate is present in the molecular formula DB of ligand molecules, three-dimensional structure initial coordinates are generated (S704). When the molecular formula of the molecule as the drug candidate is not present in the molecular formula DB of ligand molecules (NO in S703), the system is ended.

When the three-dimensional structure initial coordinates are generated, conformations are searched for (S705), and necessary conformations are extracted (S706). The extracted conformations are elaborated (S707). If the three-dimensional structure can be estimated, the estimated three-dimensional structure information of the molecule as the drug candidate is acquired (S702). If the calculation is impossible because of the performance of the computer prepared in the simulation section 3-2, the user may be notified of it.

Next, using the above-described three-dimensional structures of the target protein and the molecule as the three-dimensional structure drug candidate as initial values, simulation calculation is executed for an item designated as the contents of simulation calculation in the user presented conditions.

First, the contents of simulation calculation in the user presented conditions transmitted to the matching section are acquired (S801).

For example, according to the user presented conditions transmitted to the matching section, which are shown in Table 3, energy calculation, property calculation, and docking simulation of each molecule are executed.

Information about binding portions is obtained by causing the user to input it when the number of binding portions is known or designated by the user. If the number of binding sites is unknown, the information is obtained by automatically determining binding portions equal in number to that designated by the user at random on a protein.

As the calculation method, the method determined at the time of matching is used.

First, it is determined whether the contents of simulation calculation are designated (S802). If neither energy calculation by the method of molecular orbitals nor docking simulation is designated, the system is ended (NO in S802).

When the contents are designated (YES in S802), it is determined whether the contents of simulation calculation indicate energy calculation by the method of molecular orbitals (S803).

When not energy calculation by the method of molecular orbitals but docking simulation is designated, docking simulation by classical mechanics or QMMM docking simulation, or both of them are directly executed.

When energy calculation by the method of molecular orbitals is designated (YES in S803), energy calculation is executed by using the method of molecular orbitals (S804).

Next, it is determined whether physical quantity calculation is designed as the contents of simulation calculation (S805). When physical quantity calculation is designated (YES in S805), physical quantity calculation is executed (S807). The calculation result is input to the simulation result analysis section 3-3 (S808).

When physical quantity calculation is not designated (NO in S805), the result of energy calculation by the method of molecular orbitals is stored in the simulation result analysis section 3-3 (S806).

Next, it is determined whether docking simulation is designed as the contents of simulation calculation (S809).

When docking simulation is designated (YES in S809), docking simulation by classical mechanics or QMMM docking simulation, or both of them are executed (S810 to S815). The result of docking simulation is stored in the simulation result analysis section 3-3 (S812 and S815).

The simulation result analysis section 3-3 sends a copy of the simulation calculation result to the consultant who has got the contract for the simulation calculation through the consultant terminal apparatus 7 (S816).

The consultant adds intellectual added value information such as an analysis result or the explanation of the result while referring to the received simulation calculation result and transmits the intellectual added value information to the simulation result analysis section 3-3.

Upon receiving the intellectual added value information (S817), the simulation result analysis section 3-3 temporarily stores it (S818) and transmits the received intellectual added value information and the simulation calculation result to the user terminal apparatus 5 (S819).

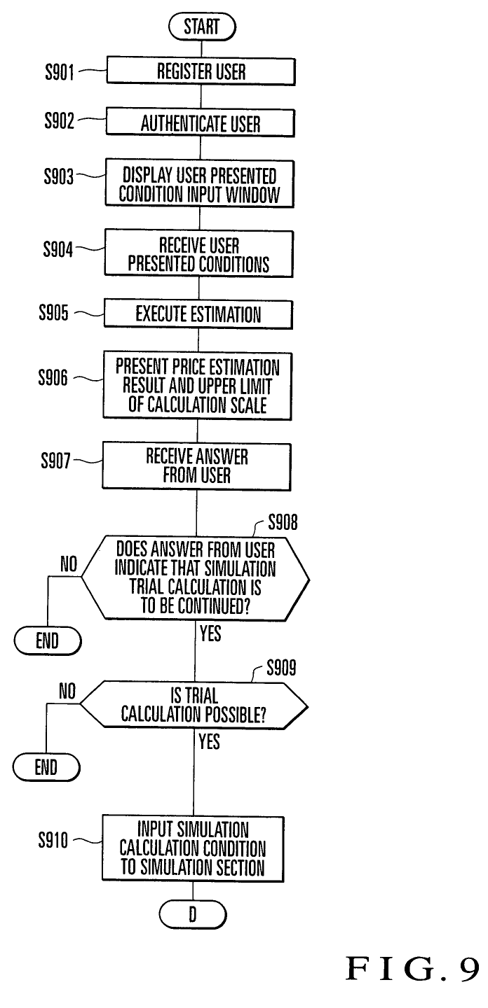

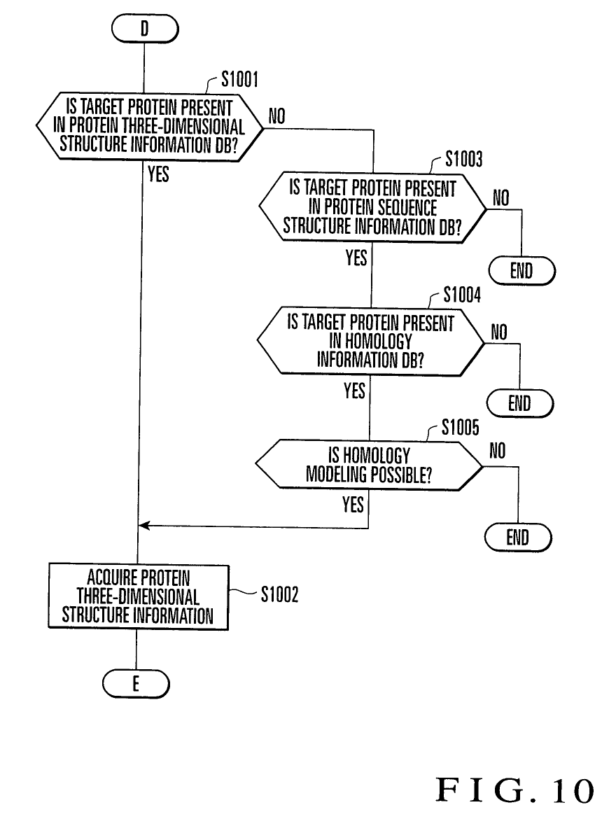

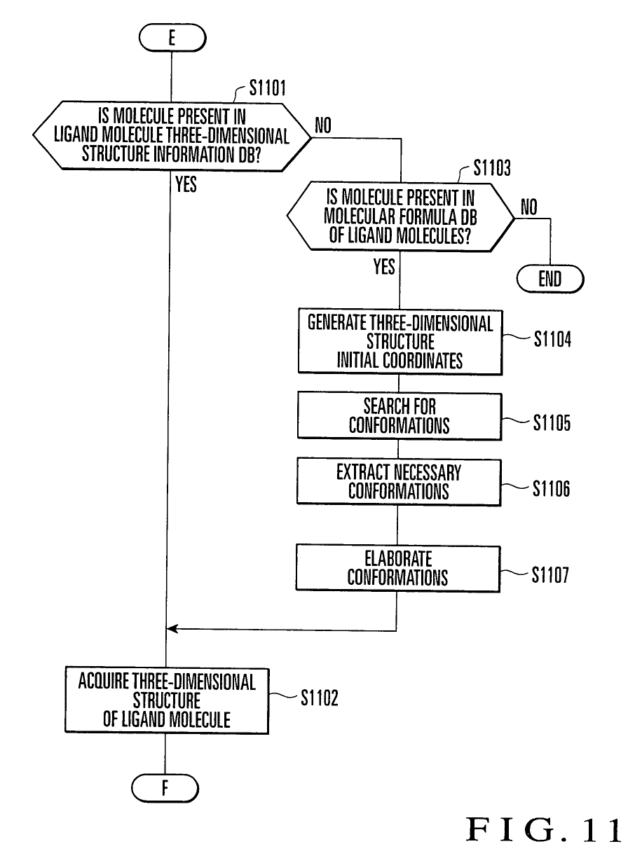

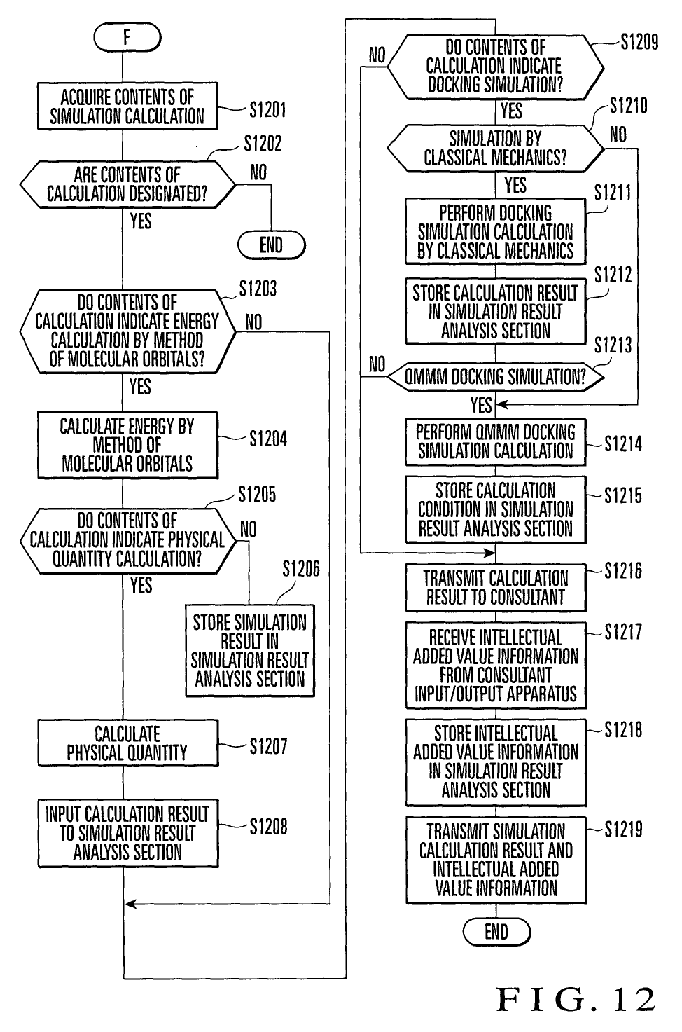

An example will be described next with reference to FIGS. 9 to 12, in which when target protein function control which is effective in the drug design field is to be executed by using the above-described simulation calculation service providing system, pieces of information about portions of the target protein, to which molecules as drug candidates bind, and the difference in affinity to the respective portions are to be collected by a non-member user by way of trial.

The user operates the user terminal apparatus 5, activates a browser stored in the storage section, and, for example, designates the address of the user management apparatus 2 on the browser to access the user management apparatus 2 through the network 6.

The authentication/registration section 2-3 of the user management apparatus 2 confirms whether the user who is accessing it has already been registered.

If user registration is not executed yet, a notification representing that the user should be registered is sent, and user registration is performed (S901). The user registration may be charged.

User authentication may be performed after user registration (S902).

When the user is granted permission to use as a result of authentication processing, a window in which simulation conditions and request items related to simulation calculation are to be input is displayed on the display section 5d of the user terminal apparatus 5 that is accessing the user management apparatus 2 (S903). The user inputs desired simulation calculation conditions and request items related to the simulation calculation.

For example, when molecular binding simulation (docking simulation) is to be used, the user inputs simulation conditions and request items related to simulation calculation as shown in Table 1 by using the browser or the like and transmits them to the user management apparatus 2. As described above, user presented conditions include “contents of simulation calculation”, “information about molecules to be calculated”, “delivery time”, “price”, and “priority item”. The items of the user presented conditions can be added or changed, as needed.

The transmitted simulation conditions and request items are received by the transmission/reception section 2-2 as user presented conditions (S904). The user presented conditions received by the transmission/reception section 2-2 are input to the calculation control section 2-7. The user presented conditions are input from the calculation control section 2-7 to the estimation section 2-8. The estimation section 2-8 estimates the price of simulation calculation on the basis of the received user presented conditions (S905).

Since this calculation is trial calculation, the calculation scale of simulation calculation to be executed by the simulation section 3-2 and the time required for calculation have upper limits. If calculation in a scale beyond the upper limit is designated, the user is notified of the upper limit value and that the user presented conditions go beyond the upper limit (S906).

The estimation result is input to the transmission/reception section 2-2. The transmission/reception section inputs the received estimation result to the information management section 2-5. The information management section 2-5 stores the received price estimation result in the storage section 2-6 (S906). The user can refer to the estimation result by operating the user terminal apparatus 5 and accessing the information management section 2-5.

The user refers to the estimation result and examines whether the simulation calculation is to be continued or the system is to be ended without executing the simulation calculation. When the simulation calculation should be continued, the user examines whether the simulation calculation should be executed on the basis of the current conditions or re-examines the simulation calculation conditions, and transmits the examination result.

This operation may be done by, e.g., displaying the simulation condition input window again and causing the user to input simulation conditions again.

The examination result transmitted from the user terminal apparatus 5 is received by the transmission/reception section 2-2 of the user management apparatus 2 (S908).

When the received examination result indicates that the simulation test calculation should be continued (YES in S908), the simulation trial calculation conditions are input from the transmission/reception section 2-2 to the estimation section 2-8 through the trial calculation section 2-10.

When the received examination result indicates that no simulation test calculation should be executed (NO in S908), the system is ended.

On the basis of the newly input user presented conditions, the estimation section 2-8 executes estimation and determines whether the simulation trial calculation goes beyond the upper limit of the processing capability of the system. If the simulation trial calculation goes beyond the upper limit of the processing capability of the system, and trial calculation cannot be executed (NO in S909), the system is ended.

When the simulation trial calculation falls within the limit of the processing capability of the system, and trial calculation can be executed (YES in S909), the simulation calculation conditions are input to the simulation section 3-2 (S910).

Upon receiving the simulation calculation conditions, the simulation section 3-2 first searches for the three-dimensional structure of the target protein (S1001).

As described above, the simulation section 3-2 has, e.g., a protein three-dimensional structure information DB (not shown), a protein sequence structure DB (not shown), and a homology information DB (not shown). The protein three-dimensional structure information DB stores information of the three-dimensional structures of proteins. The protein sequence structure DB stores information of the sequence structures of proteins. The homology information DB stores information of homology of proteins.

The three-dimensional structure of the target protein is searched for by searching the protein three-dimensional structure information DB (S1001). If it is determined as a result of search that the target protein is present in the protein three-dimensional structure information DB (YES in S1001), protein three-dimensional structure information is acquired (S1002).

When the target protein is not present in the protein three-dimensional structure information DB (NO in S1001), the sequence information of the target protein is searched for (S1003). The sequence information of the target protein is searched for by searching the protein sequence structure DB. If it is determined as a result of search that the sequence information of the target protein is present in the protein sequence structure DB (YES in S1003), homology information is searched for. When the sequence information of the target protein is not present in the protein sequence structure DB (NO in S1003), the system is ended (S1003).

Homology information is searched for by searching the homology information DB (S1004). If it is determined as a result of search that the sequence information of the target protein is present in the homology information DB (YES in S1004), it is determined whether the three-dimensional structure can be estimated by using a method such as homology modeling (S1005). If the sequence information of the target protein is not present in the homology information DB (NO in S1004), the system is ended.

When the three-dimensional structure can be estimated, the estimated protein three-dimensional structure information is acquired (S1002). If the three-dimensional structure cannot be estimated, the system is ended. If the calculation is impossible because of the performance of the computer prepared in the simulation section 3-2, the user may be notified of it.

Search of the three-dimensional structure of a molecule as a drug candidate will be described next.

For example, when no three-dimensional structure information is present, it is estimated from sequence information or by using a method of molecular mechanics, molecular dynamics, or molecular orbitals.

For example, the simulation section 3-2 has a ligand molecule three-dimensional structure information DB (not shown) and a molecular formula DB (not shown) of ligand molecules. The ligand molecule three-dimensional structure information DB stores information of the three-dimensional structures of ligand molecules. The molecular formula DB of ligand molecules stores information of the molecular formulas of ligand molecules.

The three-dimensional structure of a molecule as a drug candidate is searched for by searching the ligand molecule three-dimensional structure information DB (S1101). If it is determined as a result of search that the molecule as the drug candidate is present in the ligand molecule three-dimensional structure information DB (YES in S1101), the ligand molecule three-dimensional structure information is acquired (S1102).

When the molecule as the drug candidate is not present in the ligand molecule three-dimensional structure information DB (NO in S1101), the molecular formula of the molecule as the drug candidate is searched for (S1103). The molecular formula of the molecule as the drug candidate is searched for by searching the molecular formula DB of ligand molecules. If it is determined as a result of search that the molecular formula of the molecule as the drug candidate is present in the molecular formula DB of ligand molecules (YES in S1103), three-dimensional structure initial coordinates are generated (S1104). When the molecular formula of the molecule as the drug candidate is not present in the molecular formula DB of ligand molecules (NO in S1103), the system is ended.

When the three-dimensional structure initial coordinates are generated (S1104), conformations are searched for by using the method of molecular mechanics or molecular dynamics (S1105), and necessary conformations are extracted (S1106). The extracted conformations are elaborated by the method of molecular orbitals (S1107). If the three-dimensional structure can be estimated, the estimated three-dimensional structure information of the molecule as the drug candidate is acquired (S1102). If the calculation is impossible because of the performance of the computer prepared in the simulation section 3-2, the user may be notified of it.

Next, using the above-described three-dimensional structures of the target protein and the molecule as the three-dimensional structure drug candidate as initial values, simulation calculation is executed for an item designated as the contents of simulation calculation in the user presented conditions.

First, the contents of simulation calculation in the user presented conditions transmitted to the matching section are acquired (S1201).

For example, according to the user presented conditions transmitted to the matching section, which are shown in Table 3, energy calculation, property calculation, and docking simulation of each molecule are executed.

Information about binding portions is obtained by causing the user to input it when the number of binding portions is known or designated by the user. If the number of binding sites is unknown, the information is obtained by automatically determining binding portions equal in number to that designated by the user at random on a protein.

As the calculation method, the method determined at the time of matching is used.

First, it is determined whether the contents of simulation calculation are designated (S1202).

If neither energy calculation by the method of molecular orbitals nor docking simulation is designated, the system is ended (S1202).

When the contents are designated (YES in S1202), it is determined whether the contents of simulation calculation indicate energy calculation by the method of molecular orbitals (S1203).

When not energy calculation by the method of molecular orbitals but docking simulation is designated, docking simulation by classical mechanics or QMMM docking simulation, or both of them are directly executed.

When energy calculation by the method of molecular orbitals is designated (YES in S1203), energy calculation is executed by using the method of molecular orbitals (S1204).

Next, it is determined whether physical quantity calculation is designed as the contents of simulation calculation (S1205). When physical quantity calculation is designated (YES in S1205), physical quantity calculation is executed (S1207). The calculation result is input to the simulation result analysis section 3-3 (S1208).

When physical quantity calculation is not designated (NO in S1205), the result of energy calculation by the method of molecular orbitals is stored in the simulation result analysis section 3-3 (S1206).

Next, it is determined whether docking simulation is designed as the contents of simulation calculation (S1209).

When docking simulation is designated (YES in S1209), docking simulation by classical mechanics or QMMM docking simulation, or both of them are executed (S1210 to S1215). The result of docking simulation is stored in the simulation result analysis section 3-3 (S1212 and S1215).

The simulation result analysis section 3-3 sends a copy of the simulation calculation result to the consultant who has got the contract for the simulation calculation through the consultant terminal apparatus 7 (S1216).

The consultant adds intellectual added value information such as an analysis result or the explanation of the result while referring to the received simulation calculation result and transmits the intellectual added value information to the simulation result analysis section 3-3.

Upon receiving the intellectual added value information (S1217), the simulation result analysis section 3-3 temporarily stores it (S1218) and transmits the received intellectual added value information and the simulation calculation result to the user terminal apparatus 5 (S1219).

According to the present invention, the user need not purchase any computer or software by himself/herself. The user need not prepare any server to be connected to the Internet, either, and can use simulation through the network. For this reason, the convenience of use of simulation can be increased for temporary users and non-experts. Additionally, since change/upgrading of application software can be done by only the Internet provider, a user-friendly system can be implemented.

The user who uses this simulation calculation service system can select a consultant who can solve problems. When the user requests simulation, he/she designates a consultant having a necessary technical capability. The simulation calculation service system selects a consultant on the basis of the priority item designated by the user.

The user inputs a problem to be subjected to simulation calculation by using the user terminal apparatus. The provider manages the server system. The consultant refers to user presented conditions by using the consultant terminal apparatus, inputs bidding conditions within a predetermined period, executes simulation calculation by using the server system managed by the operator, and examines the analysis result.

The user can easily input a simulation request by using input means such as a browser and graphical user interface.

The user can change simulation calculation conditions in consideration of an estimation result. The user can also use the system by way of trial.

Since the system provider can flexibly cope with the maintenance of the system and any accident, the robustness of the system increases. Computer makers and Internet providers can prompt to find new users.

Furthermore, requirements between the user and the consultant can match. Problems of research workers can be solved by using a simulation technology established by simulation experts or IT providers and a developed simulation system. For these reasons, a new simulation technology can easily be introduced. In addition, business opportunities using simulation and market creation opportunities can be increased.

Since opportunities to use the simulation system by way of trial are given to non-member users, the opportunities to acquire users can be increased.

The system provider can efficiently operate resources such as computer hardware and software. The system provider can also efficiently collect investments for computer hardware and software.

The consultant can receive the consultant fee. The Internet provider can obtain new Internet users.

The consultant can present questions, individual proposals, and individual estimations within a predetermined period on the basis of user presented conditions. On the other hand, the user can respond to them by sending answers to the questions or sending questions to the individual proposals or individual estimations. The user can change user presented conditions on the basis of the result of response. By the above-described response, the user can know the price of simulation calculation in advance and determine by referring to the price whether simulation should be executed.

What is claimed is:

1. A simulation calculation service providing method of providing simulation calculation in a server system connected to a user terminal apparatus and a consultant terminal apparatus through a network, comprising the steps of:
receiving a condition of the simulation calculation from the user terminal apparatus as a user presented condition;
registering the received user presented condition;
receiving, from the consultant terminal apparatus, a bidding condition from a consultant in correspondence with the registered user presented condition;
comparing the user presented condition with the bidding condition and selecting a bidding condition that coincides with the user presented condition;
inquiring of the user terminal apparatus about whether the simulation calculation is to be executed on the basis of the selected bidding condition; and
executing the simulation calculation in accordance with an answer to the inquiry.

2. A method according to claim 1, further comprising the steps of
estimating a price of the simulation calculation on the basis of the received user presented condition, and
transmitting an estimation result of the estimated price to the user terminal apparatus and inquiring about whether the simulation calculation is to be executed.

3. A method according to claim 2, wherein
the estimation step comprises the step of determining on the basis of the user presented condition whether the simulation calculation can be executed, and
the inquiry step comprises the step of transmitting a determination result to the user terminal apparatus and inquiring whether the simulation calculation is to be executed.

4. A method according to claim 2, further comprising the step of, when the answer to the inquiry indicates an instruction for changing the condition of the simulation calculation, estimating the price of the simulation calculation again.

5. A method according to claim 2, further comprising the steps of
billing a user who has requested the simulation calculation the estimated price, and
paying an amount obtained by deducting a commission from the estimated price to a consultant who has made a successful bid for the simulation calculation.

6. A method according to claim 1, further comprising the step of causing the user terminal apparatus and the consultant terminal apparatus to access the server system by using at least one of an Internet provider and a LAN.

7. A method according to claim 1, further comprising the steps of
inputting the user presented condition by using one of a browser and a graphical user interface prepared in the user terminal apparatus, and other input means, and
displaying a result of the simulation calculation.

8. A simulation calculation service providing system comprising:
a user terminal apparatus which comprises simulation condition input means for inputting a simulation calculation condition, and user terminal communication means for transmitting the input simulation calculation condition as a user presented condition;
a consultant terminal apparatus which comprises consultant input means for inputting a consultant bidding condition for the user presented condition, and consultant terminal communication means for transmitting the input consultant bidding condition; and
a server system which comprises matching means comprising comparison means for comparing the user presented condition with the bidding condition, selection means for selecting a bidding condition that coincides with the user presented condition, and inquiry means for inquiring about whether simulation calculation is to be executed on the basis of the selected bidding condition, simulation means for executing the simulation calculation in accordance with an inquiry result, and transmission/reception means for transmitting the inquiry and receiving the user presented condition, the bidding condition, and an answer to the inquiry.

9. A system according to claim 8, wherein said user terminal communication means and said consultant terminal communication means access said server system through at least one of an Internet provider and a LAN.

10. A system according to claim 8, wherein said simulation condition input means comprises at least one of a browser and graphical user interface, and other input means.

11. A system according to claim 8, wherein said user terminal apparatus further comprises display means for displaying a simulation result.

12. A server system comprising:
matching means which comprises comparison means for comparing a user presented condition as simulation condition with a consultant bidding condition for the user presented condition, selection means for selecting a bidding condition that coincides with the user presented condition, and inquiry means for inquiring about whether simulation calculation is to be executed on the basis of the selected bidding condition;
simulation means for executing the simulation calculation in accordance with an inquiry result; and
transmission/reception means for transmitting the inquiry and receiving the user presented condition, the bidding condition, and an answer to the inquiry.

13. A system according to claim 12, further comprising estimation means for executing estimation about the simulation calculation on the basis of the user presented condition.

14. A system according to claim 13, wherein said estimation means comprises price estimation means for estimating a price of the simulation calculation.

15. A system according to claim 13, wherein said estimation means comprises calculation capability determination means for determining whether the simulation calculation can be executed.

16. A system according to claim 12, wherein said comparison means compares the consultant bidding condition with a rank to identify a technical capability of a consultant who is to execute the simulation calculation.

17. A system according to claim 12, wherein said comparison means selects the condition that coincide with the user presented condition on the basis of a priority of the simulation calculation condition.

18. A system according to claim 12, further comprising charging means for charging for the simulation calculation.

19. A system according to claim 12, further comprising encryption means for encrypting a signal to be transmitted.

20. A system according to claim 13, further comprising trial calculation means for executing simulation calculation by way of trial for a non-member user.

21. A system according to claim 12, further comprising
authentication means for executing member authenticating,
registration means for executing member registration of a user, and
a DB which stores information of users who have already been registered as members.

22. A system according to claim 12, further comprising
information management means for transmitting an acknowledge signal for requested information in response to an access request, and
storage means for storing a result of the simulation calculation.

23. A system according to claim 12, further comprising simulation result analysis means for transmitting, to the user terminal apparatus, intellectual added value information added by a consultant who has referred to a result of the simulation calculation together with the result of the simulation calculation.

24. A system according to claim 18, further comprising money reception means for receiving compensation for a consultant.

25. A computer-readable recording medium that records a program for causing a computer to function as:
price estimation means for estimating a price of simulation calculation on the basis of a user presented condition as a simulation condition;
calculation capability determination means for determining on the basis of the user presented condition whether the simulation calculation can be executed;
comparison means for comparing the user presented condition with a consultant bidding condition for the user presented condition;
selection means for selecting a bidding condition that coincides with the user presented condition;
inquiry means for inquiring about the simulation calculation is to be executed on the basis of the selected bidding condition;
simulation means for executing the simulation calculation in accordance with a result of the inquiry;
transmission/reception means for transmitting the inquiry about results from said price estimation means and said calculation capability determination means and receiving the user presented condition, the bidding condition, and answers to the results from said price estimation means and said calculation capability determination means;
charging means for charging for the simulation calculation;
encryption means for encrypting the inquiry, the user presented condition, the bidding condition, and the answer to the inquiry; and
trial calculation means for executing simulation calculation by way of trial for a non-member user.
